(19) United States
(12) Patent Application Publication
(10) Pub. No.: US 2011/0184902 A1
(43) Pub. Date: Jul. 28, 2011

(54) BUSINESS RULE INTEGRATION WITH ENGINEERING APPLICATIONS

(75) Inventors: Xiaoming Feng, Cary, NC (US); Khosrow Moslehi, Palo Alto, CA (US); Mani Subramanian, Sugarland, TX (US)

(73) Assignee: ABB RESEARCH LTD., Zurich (CH)

(21) Appl. No.: 13/054,489

(22) PCT Filed: Jul. 14, 2009
(86) PCT No.: PCT/US09/50496

§ 371 Date: Mar. 31, 2011

Related U.S. Application Data
(60) Provisional application No. 61/083,195, filed on Jul. 24, 2008.

(51) Int. Cl. G06N 5/02

(52) U.S. Cl. 706/47

(57) ABSTRACT

The system integrates a business rule engine with an engineering application that performs one or more predetermine functions relating to the monitoring, analyzing or controlling of a physical system. Rule processing requests are transmitted from the engineering application to a rule based service which manages the data retrieval, data insertion, rule engine invocation activities in a two pass design so as to optimize the rule processing performance for online system monitoring and control.

### BACKGROUND OF THE INVENTION

Business rule engines are software systems that process, (i.e. execute) one or more business rules in a runtime production environment. Business rule engines are adapted to perform a wide variety of analytical functions, and are suitable for many business uses. While business rule engines are very flexible, certain technical issues pose a barrier to applying business rule engines to system monitoring and control problems.

One problem that business rule engines encounter is slow execution time when a large number of state variables are encountered (the number could range from hundreds of thousands to millions). Only a small percentage of the multitude of state variables are used (either referenced or modified) by any given monitoring or control rule execution. However, prior to rule execution, the system does not know which state variables will be required. For the rule engine to process any rules, the state variables that are referenced by the rules must be uploaded (inserted) into the working memory of the rule engine. One solution is to load all state variables into the working memory of the rule engine. However, this solution is typically not suitable for time critical applications, or applications having limited computing resources. This is because it takes a considerable amount of computer time to upload and update thousands or hundreds of thousands of variables into the working memory. For example, in applications for a power distribution system, the monitoring and control applications must be invoked repeatedly from within real-time mission critical engineering applications. Common design patterns of commercial off-the-shelf business rule engines do not provide the necessary process speeds needed in these critical engineering systems.

Thus, there is a need in the art for a system that can utilize business rule engines while achieving processing speeds necessary in time-sensitive applications.

### SUMMARY OF THE INVENTION

According to one aspect of the present invention, a method is disclosed for integrating a rule engine, having a working memory, with an engineering application that performs one or more predetermine functions relating to an electrical transmission system. The functions include monitoring, analyzing or controlling the electrical transmission system. The method includes transmitting an analysis request from the engineering application to the business rule engine. One or more rules is executed in the business rule engine in a first process in response to the analysis request, wherein during the first process the working memory of the rule engine is not populated with data required by the one or more rules. The data required by the one or more rules is acquired. The data required by the one or more rules is input into the working memory of the rule engine. The one or more rules in the business rule engine are executed in a second process to generate execution results. The results of the second process are transmitted to the engineering application which performs the one or more predetermined functions using the execution results.

According to another aspect of the present invention, a system is disclosed for performing one or more predetermined functions relating to a physical system. The predetermined functions include monitoring, analyzing or controlling the physical system. The system includes a data acquisition system that monitors at least one variable of the physical system and outputs monitored data. A data server receives and stores the monitored data. An engineering application program receives the monitored data from the data server and includes a graphical user interface through which an operator may initiate at least one of the predetermined functions. A business rule engine includes a working memory, the business rule engine is adapted to make determinations based on rules formulated in terms of a business vocabulary. The rules are grouped in rule packages. A rule based services module includes a master data buffer, the rule based service module facilitates communication between the business rule engine and the engineering application. The master data buffer includes a cross reference list relating each package to monitored data necessary for execution of the rule package. The rule based services module transmits the monitored data necessary for an executing rule package from the master data buffer to the working memory.

According to yet another aspect of the present invention, at least one computer-readable medium is disclosed containing computer-readable instructions for aiding an engineering application to perform one or more predetermined functions including monitoring, analyzing or controlling a physical system. When executed, the computer-executable instructions perform steps including transmitting an analysis request from an engineering application to a business rule engine. The execution of one or more rules is initiated in the business rule engine in a first process in response to the analysis request, wherein during the first process the working memory of the rule engine is not populated with data required by the one or more rules. The data required by the one or more rules is acquired. The data required by the one or more rules is transmitted to the working memory of the rule engine. The execution of the one or more rules in the business rule engine is initiated in a second process to generate execution results. The results of the second process are transmitted to the engineering application, wherein the engineering application performs the one or more predetermined functions using the execution results.

### BRIEF DESCRIPTION OF THE DRAWINGS

The features, aspects, and advantages of the present invention will become better understood with regard to the following description, appended claims, and accompanying drawings where:

FIG. 1 is a schematic view of a system according to the present invention;

FIG. 2 is an activity diagram illustrating the overall process according to the present invention;

FIG. 3 is an activity diagram illustrating the process of invoking the rule based service module according to the present invention;

FIG. 4 is a activity diagram illustrating the Phase I process of the rule base service module; and

FIG. 5 is an activity diagram illustrating the Phase II process of the rule based service module.

### DESCRIPTION OF THE INVENTION

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

The present invention is an optimal decomposed design for incorporating a business rule engine into a system that monitors, simulates and/or controls a physical system. Throughout this disclosure, a power system is discussed as an exemplary physical system, however, it should be appreciated that other uses beyond that of power control systems are contemplated. Generally, the present invention incorporates a business rule engine into a control/monitoring/simulation system in a manner that allows greater flexibility and ease of modification. As will be hereinafter described, the system of the present invention achieves fast performance by, among other things, decomposing rule sets into an optimal size, interleaving data retrieval with rule engine firing, delaying and aggregating data retrieval, utilizing a master data buffer, and generating cross reference maps. As will become apparent the system and method of the present invention achieves improved performance in the form of faster process and analysis times while providing the flexibility and ease of use that business rule engines provide.

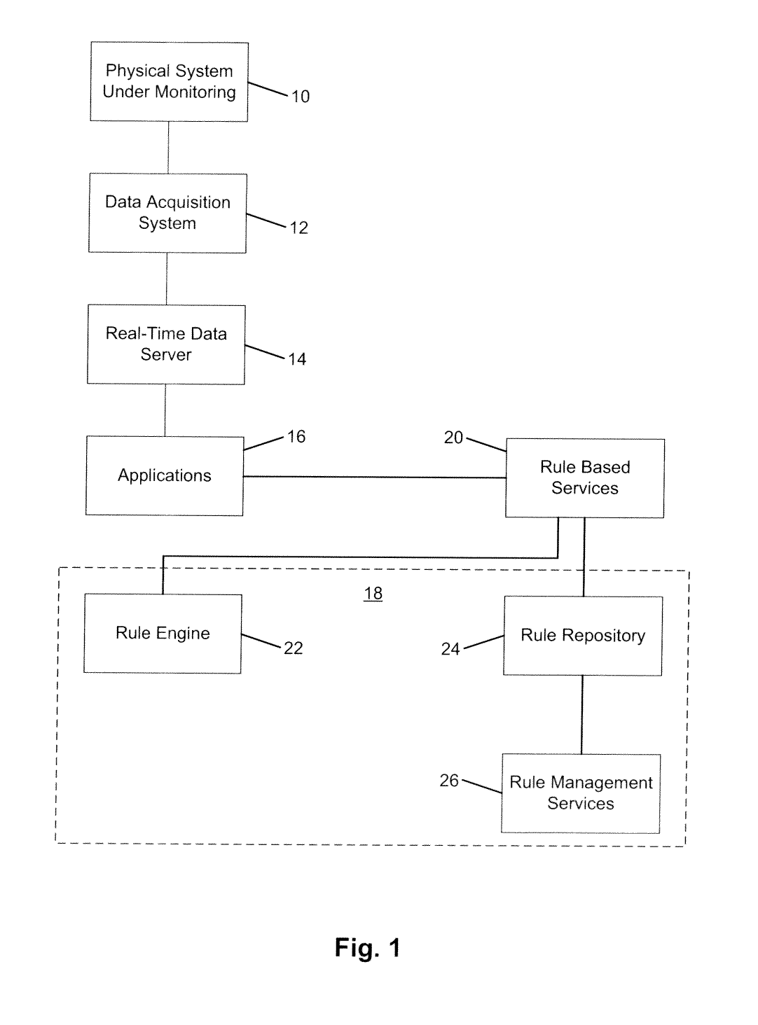

With reference now to FIG. 1, it can be seen that a physical system 10 includes one or more system variables. These system variables are monitored by a data acquisition system 12. As discussed above, the present invention may be suitable for any number of physical systems and/or data acquisition systems. As an example, the physical system 10 could be a power distribution network and the data acquisition system could be a supervisory control and data acquisition system (SCADA). In such an example, exemplary monitored variables may include line currents, circuit breaker and transformer status, node voltage levels, etc.

The data acquisition system 12 transmits the collected data to a real-time data server 14 which, for each monitored variable, stores the most recently received information. In this manner, the real-time data server 14 stores a snapshot of the most current system information. The data server 14 provides data access service to one or more analytical/engineering applications 16. Application 16 may be any application that is adapted to receive data from the data server 14 and in turn analyze, simulate, and/or control the physical system 10. The application 16 may be located in a control room and include a graphical user interface through which an operator may observe monitored data, initiate system commands, analyze system data and/or initiate simulations. As an example, if the physical system is a power distribution/transmission network, the application may be an energy management system (EMS) having a load flow analysis application, a dispatch training simulator application, a state estimation application, etc.

In the past, each analytical application 16 performed all necessary calculations and logic process within the application. The present invention enables the application 16 to delegate some common logical calculations to a business rule service module 20, which in turn relies on business rule engine 18 to carry out the logic processing. The advantage in such a system is that the creation and modification of the analytical rules are much simpler for the end user. Specifically, in the past, a rule change within an application required the services of a computer programmer. Thus, any time the underlying business logic changed, requiring a modification to certain rules, the end user had to again contract a computer programmer knowledgeable of the application to rewrite the code. Such an arrangement is often described as a specialist-developer relationship, wherein the specialist has knowledge of the monitored system and must instruct a developer who only has knowledge of the specific software application. The present invention substantially reduces the need for the developer (computer programmer) in many instances, as business rule engines are typically written in natural language form, making it much easier to create, modify, and remove rules.

As discussed above, simply using a business rule engine for analysis may slow the process considerably. In order to increase processing speed and ease of use, the present invention incorporates a rule based service module 20 to function as an intermediary between the business rule program 18 and the application 16. The rule based service module serves several purposes. First, it insulates the engineering application from direct interactions with the rule engine program and provides a simple service oriented interface to the application. Second, it provides a central location from which performance optimization may be accomplished. The rule based service module 20 receives logic processing service requests from the application 16, manages the data retrieval and interaction with rule engine instances, captures the rule processing results, and transmits the logic processing results from the business rule engine back to the application. The rule based service module is provided as a separate module, allowing the rule based service to be shared by multiple applications 16.

Any number of business rule programs 18 may be used in the present invention. Business rule program 18 includes a rule engine 22 for executing the rules, a rule repository 24 for storing a plurality of rules, and a rule management services module that enables a user to create and modify the rules. Examples of suitable business rule programs include JRULES, provided by ILOG Inc, and JBOSS Rules by JBOSS.

Business rule engines make determinations based on rule sets formulated in terms of a business vocabulary. These rules in turn depend on an underlying execution model that corresponds to domain data objects. For purposes of the present disclosure, certain terms are defined as follows. A “rule” is an IF-THEN statement defined by an end user, which represents the inference logic to be applied by the rule engine. A rule may reference one or more objects in the IF or THEN clauses. An “object” is the software representation of a real world object, such as a customer, a transformer or a transmission line. An object consists of one or more attributes or state variables (i.e. qualities or features, such as, for example, the name of a piece of equipment, the energization status of a circuit, or the voltage measurement estimate of a network node).

As discussed above, business rule engines include a working memory that is utilized to store the state variables necessary to execute the rules. As will be hereinafter discussed in greater detail, the present invention utilizes a double-pass rule engine firing approach that achieves both solution flexibility and improved performance. Such an approach involves invoking the rule engine twice for each rule package, which is accomplished using simple auxiliary rules that the user can write after the rule based services module has been deployed. An example of an auxiliary rule is of the form “If there is no customer named ‘John Smith’ (in the working memory) then get customer named ‘John Smith’ (from the data base). When the rule engine is first invoked with an empty working memory, these auxiliary rules are activated due to the absence of the specific data object in the working memory and result in retrieval requests being generated for the specific data objects. Based on the first rule engine invocation, the rule based service module then determines all the state variables needed by the rule engine for a particular application request, retrieves the necessary data from the application or database server, instantiates the data objects, and organizes them in a master data buffer. The rule engine is then invoked a second time before which the working memory is populated with all the necessary state variables needed by a specific rule engine instance. Such an approach improves performance in several ways. First, the rule engine is executing with only the necessary state variables, thus eliminating superfluous data in the working memory that would otherwise inhibit processing speed. Second, instead of many small information requests that would otherwise incur undesired computational overhead, the requests are intercepted, aggregated and transmitted to the data server in larger, less numerous requests. The data fetched from the server is stored by the rule based service module in the master data buffer and only the state variables required for the processing of a specific rule or rule package are loaded into the working memory of the rule engine. As will be discussed later in greater detail, this process is aided by a reference map that associates rules with required state variables.

The present invention further increases process efficiency by grouping rules into packages for the rule engine to process. Often times, an application request involves the execution of a plurality of rules. In cases where many rules are invoked performance may be affected. By grouping sets of rules into packages, an optimal number of rules may be executed by the rule engine. Finding the optimal rule package size rests on the understanding that rule engine performance is not linear with respect to package size (i.e. the number of rules per package). For rules that are not combinatorial (i.e. rules that are not interdependent on other rules) the processing time of the rule engine is approximately proportional to the product of the number of rules times the number of data objects in the working memory. Performance may therefore be optimized by multiple rule engine executions each with smaller rule packages and processing the packages one at a time in sequential order. It should be appreciated, however, if the rule packages are made too small (granularity too small), the performance may suffer because the overhead of processing too many rule packages increases and offsets the benefit of smaller rule packages. Thus, the rule based service module allows a user to set default and custom rule package sizes that enables a user to easily experiment with different rule package granularity. This enables the user to find optimal or near optimal rule package sizes for a given application and/or rule type.

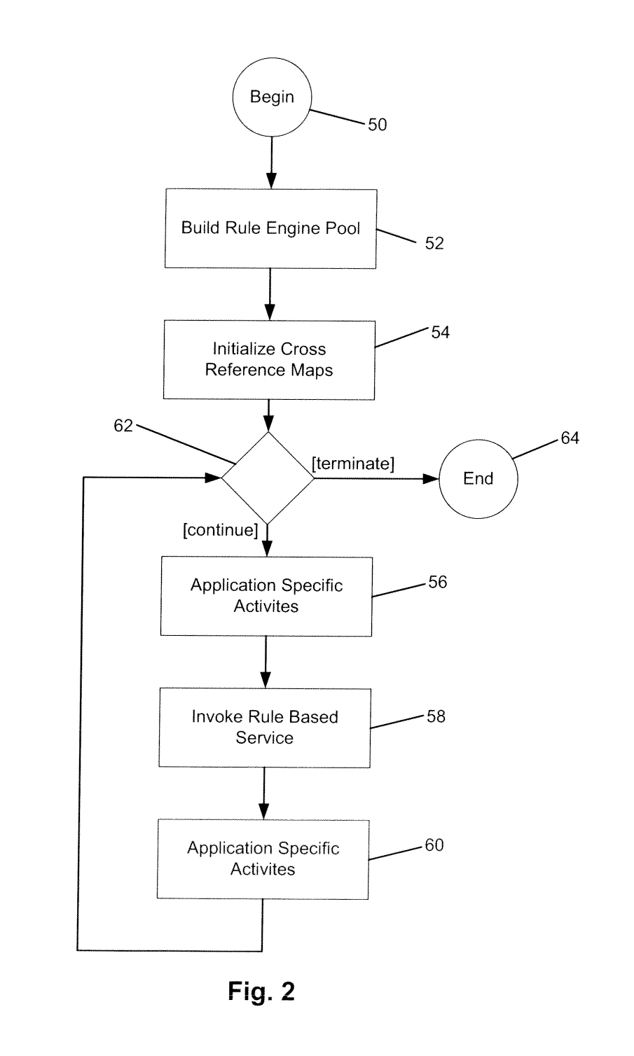

With reference now to FIG. 2, a flow chart illustrates the process of the present invention. At a step 50, an application transmits an initialization request to the rule based service module to prepare to perform an analysis/calculation. Upon receiving the request, at 52 a pool of rules is built including a collection of rule packages. In one or more embodiments, the application program signals to the rule based service module which set of rules to be used. In one embodiment, the application program provides the pathname to a file directory where the rule packages are deployed. As discussed above, each rule package is a collection of rules defined by the user. At step 54 the cross reference maps are initialized (i.e. created but not having any reference data therein). At step 56 application specific activities are performed. For example, if the application is an energy management system, the application specific activities may include some simulation analysis, which results in updating some or all of a relevant set of state variables. At step 58 the rule based service is invoked to perform rule processing for the application, and as will be described in greater detail below, double-pass engine firing is performed. In this manner the rule engine executes and returns the results of the invocation to the calling application. At step 60 the calling application may use the results to modify the system model or carry on with further simulation and/or analysis. At step 62 the process is terminated, or is continued if further rule execution is required.

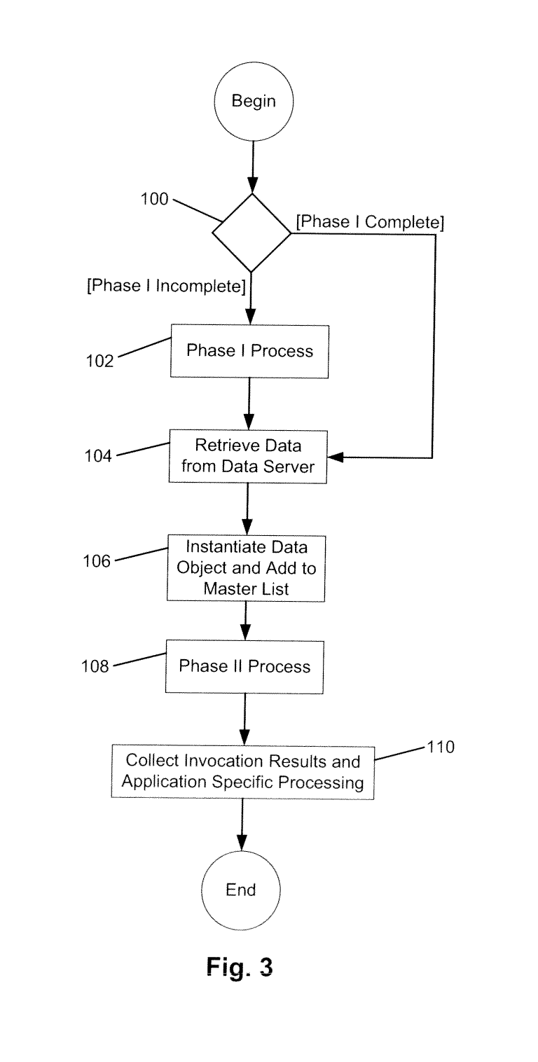

With reference now to FIG. 3, a more detailed illustration is shown of the rule based service invocation (step 58). At step 100, it is determined whether phase one processing has already occurred. If not, a first phase process is performed at step 102. In phase I, the rule engine instances are fired, with empty working memory. For purposes of the present disclosure, rule engine instance refers to the run time process/object in the volatile memory of a computer. The empty working memory triggers data fetch rules which are loaded in to the rule engine instance. The rule based service module captures and aggregates the data requests to minimize data access operations. State variables are then fetched from the data server at 104 and at step 106 the programming objects are instantiated and added to the master data buffer. The rule engine instances are again fired in a phase two process at step 108, except now all the required state variables are inserted into the rule engine instances. Thus, for each rule package, the necessary data is available and uploaded from the master data buffer to the working memory as required by the rule packages. At 110 the results are collected by the rule based service module and transmitted to the calling application.

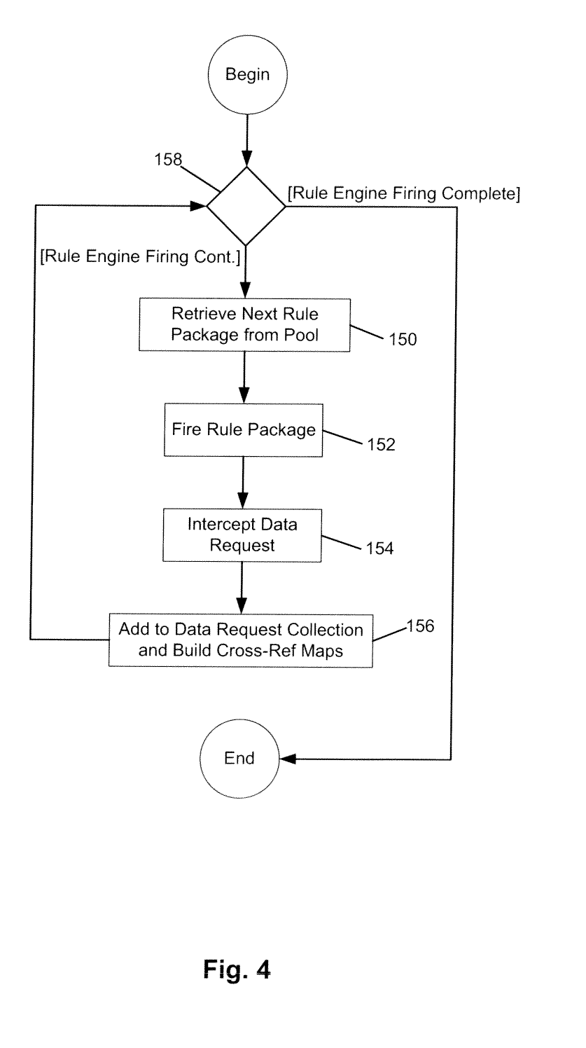

With reference to FIG. 4, a more detailed description of the phase one process is shown. At 150 the next (or first) rule package is retrieved from the pool. At 152 the rule package is executed by the rule engine. At 154, any data requests from the rule engine are intercepted and aggregated by the rule based service module. At 156, the data requests are added to a data request collection and a cross reference map is concurrently build which correlates each rule package to the specific requested data. At 158 it is determined whether additional rule engine instances from the pool remain to be executed. If so, the loop is repeated, if not, the process terminates. During this process the rule engine packages are fired in sequence.

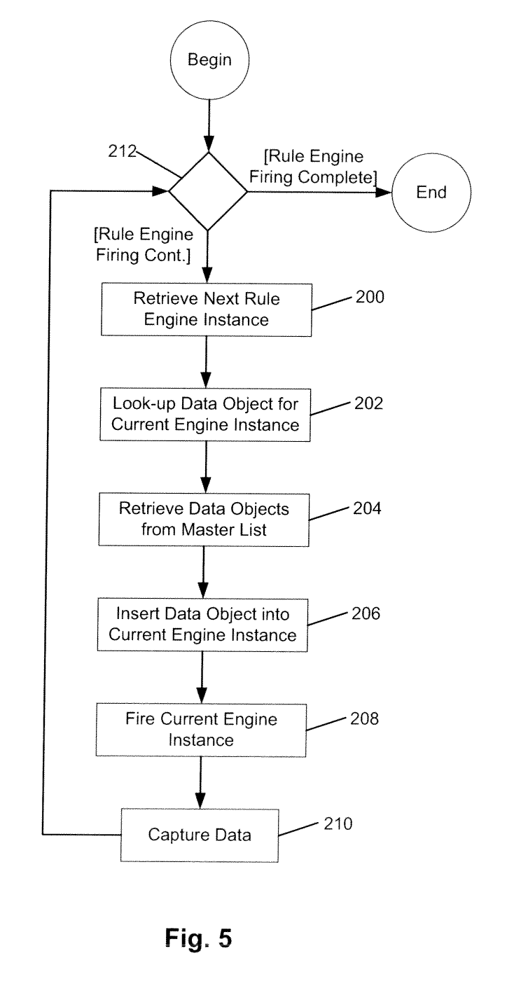

As shown in FIG. 3, after the Phase I processing the state variables are then fetched from the data server and the programming objects are instantiated and added to the master data buffer. With reference to FIG. 5, a more detailed description of the Phase II processing is shown. At 200 the next (or first) rule package is drawn from the pool. At 202, the required data objects are located for the current rule package using the cross reference map. At 204 the data objects are retrieved from the master data buffer and at 208 are inserted into the working memory for the current engine instance. At 208 the engine instance is executed and the resulting data is captured at 210. At 212 it is determined whether additional rule engine instances from the pool remain to be executed. If so, the loop is repeated, and if not, the process terminates. The result from rule processing is then transmitted to the calling application, which then decides how to use that result based on application specific requirement.

As will be appreciated by one of ordinary skill in the art, the present invention may be embodied as or take the form of the method and system, as well as of a computer readable medium having computer-readable instructions stored thereon which, when executed by a processor, carry out the operations of the present inventions as previously described and defined in the corresponding appended claims. The computer-readable medium may be any medium that can contain, store, communicate, propagate, or transport the user-interface program instruction for use by or in connection with the instruction execution system, apparatus, or device and may by way of example but without limitation, be an electronic, magnetic, optical, electromagnetic, infrared, or semiconductor system, apparatus, device, or propagation medium or other suitable medium upon which the program is printed. More specific examples (a non-exhaustive list) of the computer-readable medium would include: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Computer program code or instructions for carrying out operations of the present invention may be written in any suitable programming language provided it allows achieving the previously described technical results.

The present invention achieves improved performance targets while maintaining the flexibility expected from business rule based solutions. The system and method according to the present invention improves performance by several orders of magnitude, over the standard approach of loading all state variables into the working memory. It is thus feasible to use lower cost mainstream business rule engines and off-the-shelf hardware to perform the demanding applications, such as the control and monitoring engineering applications discussed above.

What is claimed is:

1. A method of integrating a rule engine, having a working memory, with an engineering application performs one or more predetermine functions relating to an electrical transmission system, the functions including monitoring, analyzing or controlling the electrical transmission system, the method comprising;
transmitting an analysis request from the engineering application to the business rule engine;
executing one or more rules in the business rule engine in a first process in response to the analysis request, wherein during the first process the working memory of the rule engine is not populated with data required by the one or more rules;
acquiring the data required by the one or more rules;
inputting the data required by the one or more rules into the working memory of the rule engine;
executing the one or more rules in the business rule engine in a second process to generate execution results;
transmitting the results of the second process to the engineering application; and
performing the one or more predetermined functions using the execution results.

2. The method according to claim 1 further comprising, grouping said one or more rules into rule packages.

3. The method according to claim 2 wherein said step of executing the one or more rules in the business rule engine further includes executing the rule packages in sequential order.

4. The method according to claim 1 wherein said step of acquiring the data required by the one or more rules further comprises aggregating data requests from the rule engine and transmitting the aggregated data requests to a data source.

5. The method according to claim 4 further comprising receiving data required by the one or more rules from the data source; storing the data required by the one or more rules in a master data buffer; and transmitting the data required by the one or more rules from the master data buffer to the business rule engine.

6. A system for performing one or more predetermined functions relating to a physical system, the predetermined functions including monitoring, analyzing or controlling the physical system, the system comprising;
a data acquisition system that monitors at least one variable of the physical system and outputs monitored data;
a data server receives and stores the monitored data;
an engineering application program receives the monitored data from the data server and includes a graphical user interface through which an operator may initiate at least one of the predetermined functions;
a business rule engine including a working memory, the business rule engine adapted to make determinations based on rules formulated in terms of a business vocabulary, the rules being grouped in rule packages;
a rule based services module includes a master data buffer, the rule based service module facilitates communication between the business rule engine and the engineering application, the master data buffer including a cross reference list relating each package to monitored data necessary for execution of the rule package, the rule based services module transmitting the monitored data necessary for an executing rule package from the master data buffer to the working memory.

7. The system of claim 6 wherein the rule based services module is adapted to initiate the execution of one or more rule packages in the business rule engine in a first process, wherein during the first process the working memory of the business rule engine is not populated with the monitored data necessary for an executing rule package; acquire the monitored data necessary for an executing rule package and inputs it into the master data buffer; input the monitored data necessary for an executing rule package into the working memory of the rule engine; and initiate the execution of the one or more rule packages in the business rule engine in a second process to generate execution results.

8. At least one computer-readable medium containing computer-readable instructions for aiding an engineering application to perform one or more predetermined functions including monitoring, analyzing or controlling a physical system, wherein, when executed, the computer-executable instructions perform steps comprising:
transmitting an analysis request from an engineering application to a business rule engine;
initiating the execution of one or more rules in the business rule engine in a first process in response to the analysis request, wherein during the first process the working memory of the rule engine is not populated with data required by the one or more rules;
acquiring the data required by the one or more rules;
transmitting the data required by the one or more rules into the working memory of the rule engine;
initiating the execution of the one or more rules in the business rule engine in a second process to generate execution results;
transmitting the results of the second process to the engineering application, wherein the engineering application performs the one or more predetermined functions using the execution results.

9. The at least one computer readable medium according to claim 8 further comprising the step of, grouping said one or more rules into rule packages.

10. The at least one computer readable medium according to claim 9 wherein said step of executing the one or more rules in the business rule engine further includes executing the rule packages in sequential order.

11. The at least one computer readable medium according to claim 8 wherein said step of acquiring the data required by the one or more rules further comprises aggregating data requests from the rule engine and transmitting the aggregated data requests to a data source.

12. The at least one computer readable medium according to claim 11 further comprising the steps of receiving data required by the one or more rules from the data source; storing the data required by the one or more rules in a master data buffer; and transmitting the data required by the one or more rules from the master data buffer to the business rule engine.
